(19) United States
(12) Patent Application Publication
(10) Pub. No.: US 2026/0170971 A1
(43) Pub. Date: Jun. 18, 2026

(54) Visual Reading Decoding System And Methods Of Performing The Same

(71) Applicant: David Simpson, Land O Lakes, FL (US)

(72) Inventor: David Simpson, Land O Lakes, FL (US)

(21) Appl. No.: 19/529,529

(22) Filed: Feb. 4, 2026

Related U.S. Application Data
(63) Continuation-in-part of application No. 19/288,068, filed on Aug. 1, 2025, now abandoned.
(60) Provisional application No. 63/679,360, filed on Aug. 5, 2024.

(51) Int. Cl. G09B 7/04; G09B 5/02

(52) U.S. Cl. CPC G09B 7/04; G09B 5/02

(57) ABSTRACT

A method for learning phonetic pronunciation of words utilizing a plurality of learning modules includes presenting a first learning module of the plurality of learning modules to a student user at a difficulty tier; eliciting the student user to perform the learning module; tracking a performance of the student user in performing the learning module; determining if the performance of the student user exceeded a target threshold; if the performance of the student user did not exceed the target threshold, eliciting the student user to perform the learning module at the same difficulty tier; and if the performance of the student user exceeds the target threshold, eliciting the student user to perform the learning module at another difficulty tier and/or another learning module at the same difficulty tier.

### STATEMENT OF RELATED APPLICATION(S)

This application is a continuation-in-part of U.S. patent application Ser. No. 19/288,068, entitled “Visual Reading Decoding System and Methods of Performing the Same” filed on Aug. 1, 2025, which claims the benefit of U.S. Provisional Patent Application No. 63/679,360, entitled “Visual Reading Decoding System and Methods of Performing the Same” filed Aug. 5, 2024, the disclosures of which are hereby incorporated by reference herein in its entirety.

### TECHNICAL FIELD

This invention relates to the field of aids for teaching students who experience difficulty learning to read, and systems and methods thereof.

### BACKGROUND

Reading is a required skill that should be mastered at a young age. However, there are a number of challenges that make reading difficult, if not impossible. One of the primary challenges a person can experience in learning to read is having difficulty with the concept of reading decoding, the foundational literacy skill of translating printed letters (graphemes) into spoken sounds (phonemes) to recognize and pronounce written words. People who find reading decoding to be challenging often struggle with the process of learning the vowel sounds that occur in a word, instead blending all of the sounds within the word to determine what word is being read, and to continue the process of reading the words that make up a given sentence. Learning the sounds that individual vowels make is the most difficult task in reading decoding, the primary task involved in beginning to learn to read. Success in overcoming the challenge of learning specific vowel sounds is often directly related to the instructional method employed.

Overcoming the reading decoding challenges described above requires hours of training and education, mostly in a one-on-one or a small group setting with a professional educator. With more and more strain placed on personal time by a busy world, one-on-one education sessions are extremely hard to schedule and maintain a consistent routine. In order to effectively learn to decode sounds and words when reading, a person must practice what they have learned.

Therefore, a need exists for a system that assists an individual with learning to decode vowel and letter sounds when reading words as well as allow the person to practice and reinforce decoding skills.

### SUMMARY

One aspect of the present invention according to a first embodiment includes a method for learning phonetic pronunciation of words utilizing a plurality of learning modules including presenting a first learning module of the plurality of learning modules to a student user at a difficulty tier; eliciting the student user to perform the learning module; tracking a performance of the student user in performing the learning module; determining if the performance of the student user exceeded a target threshold; if the performance of the student user did not exceed the target threshold, eliciting the student user to perform the learning module at the same difficulty tier; if the performance of the student user exceeds the target threshold, eliciting the student user to perform the learning module at another difficulty tier and/or another learning module at the same difficulty tier.

Another aspect includes eliciting the student user to perform the learning module further including presenting one or more words to the student user and presenting an audio of the one or more words being pronounced aloud to the student user; eliciting the student user to pronounce the one or more words aloud; and recording the student user pronouncing the one or more words aloud.

Another aspect includes the tracking a performance of the student user in performing the learning module further including comparing the presented audio of the one or more words being pronounced aloud to the recorded audio of the student user pronouncing the one or more words aloud; and determining one or more scores of the student user pronouncing each of the one or more words aloud.

Another aspect includes the one or more scores including a pronunciation score, an accuracy score, a fluency score, and/or a comprehension score.

Another aspect includes the determining if the performance of the student user exceeded a target threshold further including comparing the one or more scores with a predetermined target threshold score.

Another aspect includes wherein eliciting the student user to perform the learning module further including presenting to the student user one or more words; eliciting the student user to determine letter patterns and/or vowel patterns in each of the one or more words; eliciting the student user to apply letter capitalization rules; and eliciting the student user to apply letter covering pictographs.

Another aspect includes wherein the method comprises at least three difficulty tiers.

Another aspect includes a first difficulty tier of the at least three difficulty tiers comprises displaying one or more words to the student user with pictographs replacing vowel and vowel sound combinations; a second difficulty tier of the at least three difficulty tiers comprises displaying the one or more words to the student user with the pictographs placed above the vowel and vowel sound combinations; and a third difficulty tier of the at least three difficulty tiers comprises displaying the one or more words to the student user without any pictographs.

Another aspect includes the eliciting the student user to perform the learning module at another difficulty tier and/or another learning module at the same difficulty tier is accomplished automatically or by a teacher user.

In another aspect, any one or more aspects or features described herein may be combined with any one or more other aspects or features for additional advantage.

Other aspects and embodiments will be apparent from the detailed description and accompanying drawings.

Those skilled in the art will appreciate the scope of the present disclosure and realize additional aspects thereof after reading the following detailed description of the preferred embodiments in association with the accompanying drawing figures.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 is a flow diagram of a method of phonetically parsing a word according to a first embodiment of the invention.

FIG. 2. is an exemplary chart illustrating pictographs and associated vowel and vowel sound combinations used in conjunction with the method of FIG. 1.

FIG. 3 is an exemplary chart illustrating pictographs and displayed words used in conjunction with the method of FIG. 1.

FIG. 4 is a flow diagram of a method of instructing and evaluating a student user, used in conjunction with the method of FIG. 1.

FIG. 5 is a flow diagram of a method of increasing a difficulty tier within a learning module used in conjunction with the method of FIG. 1.

FIG. 6A is a flow diagram of a method of reinforcing vowel and vowel sound combination recognition, used in conjunction with the method of FIG. 1.

FIG. 6B is an exemplary chart illustrating vowel and vowel sound recognition, used in conjunction with the method of FIG. 6A.

FIG. 7 is a flow diagram of a method of incorporating audio and speaking components within a learning module, used in conjunction with the method of FIG. 1.

### DETAILED DESCRIPTION

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

It will be understood that when an element such as a layer, region, or substrate is referred to as being “on” or extending “onto” another element, it can be directly on or extend directly onto the other element or intervening elements may also be present. In contrast, when an element is referred to as being “directly on” or extending “directly onto” another element, there are no intervening elements present. Likewise, it will be understood that when an element such as a layer, region, or substrate is referred to as being “over” or extending “over” another element, it can be directly over or extend directly over the other element or intervening elements may also be present. In contrast, when an element is referred to as being “directly over” or extending “directly over” another element, there are no intervening elements present. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

Relative terms such as “below” or “above” or “upper” or “lower” or “horizontal” or “vertical” may be used herein to describe a relationship of one element, layer, or region to another element, layer, or region as illustrated in the Figures. It will be understood that these terms and those discussed above are intended to encompass different orientations of the device in addition to the orientation depicted in the Figures.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

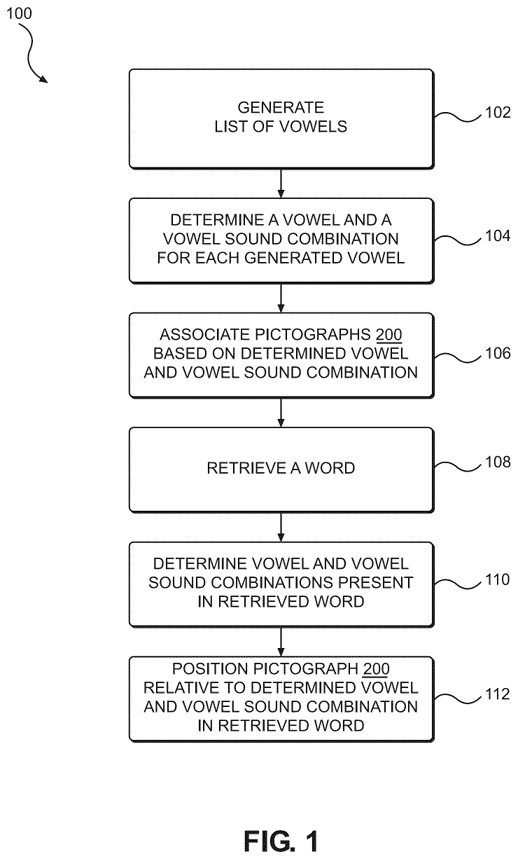

Referring now to FIG. 1, a flow diagram of a method 100 of phonetically parsing a word is shown. In step 102, the method 100 comprises generating a list of vowels that are commonly used in words. In an exemplary embodiment, the list of vowels may include vowels of the English language alone or in vowel groupings. In an alternative embodiment, the list of vowels may include vowels utilized in languages other than English. In an exemplary embodiment, the list of vowels may include vowels of the Latin alphabet, the Arabic alphabet, the Devanagari alphabet, the Cyrillic alphabet, the character-based alphabets, and/or any other known alphabet. In step 104, the method 100 comprises determining the combination of vowel and vowel sound for each generated vowel 102. In an exemplary embodiment, a single vowel generated in step 102 may have multiple vowel sounds associated therewith. For example, the English vowel “e” may have both short and long vowel sounds associated therewith. In an exemplary embodiment, the method 100 therefore determines a unique combination of a vowel and a corresponding vowel sound for each generated vowel in step 102.

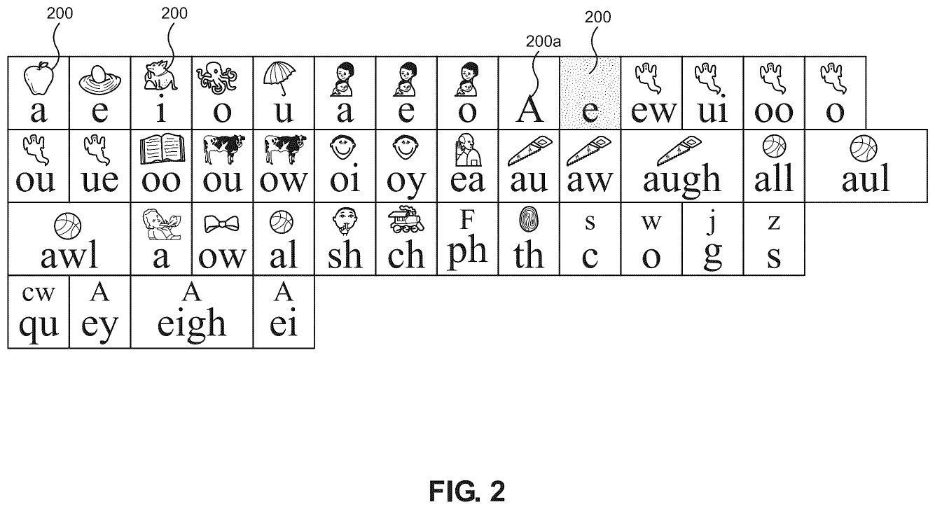

In step 106, the method 100 comprises associating a pictograph 200 (see FIG. 2) with each vowel and vowel sound combination determined in step 104. Each pictograph 200 is an image of a common word or action readily understandable by a student user 900. For example, the vowel and vowel sound combination of the short “a” (phonetically written æ) may be represented by a pictograph 200 of an apple (see FIG. 2). In an alternative embodiment, the pictograph 200 may comprise a capital form of the vowel to indicate the long vowel pronunciation. For example, the letter “a” may have pictograph 200 shown as “A” to represent the sound (see FIG. 2). In an exemplary embodiment, a pictograph 200 may be associated with more than one vowel and vowel sound combination, if the vowel sound is the same with a different vowel present. For example, the vowel and vowel sound combinations for “all”, “aul”, and “awl” may each be represented by the pictograph 200 of a ball since the vowel sound to pronounce them is the same (see FIG. 2). In an exemplary embodiment, the pictograph 200 may comprise a color square placed over the associated vowel and vowel sound combination. For example, for a silent “e” at an end of a word, a colored square may be placed over the vowel and vowel sound combination to indicate that it is not pronounced. In FIG. 2, there is illustrated a plurality of exemplary pictographs 200 and their associated vowel and vowel sound combinations.

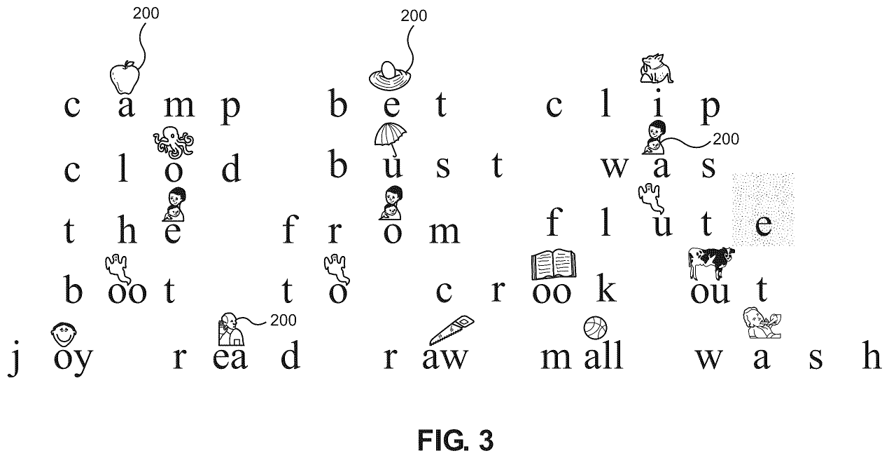

In step 108, the method 100 comprises retrieving a word from a plurality of available words to be presented to the student user 900; or, alternatively, retrieving a sentence or phrase from a plurality of available sentences and phrases. In step 110, the method 100 further comprises determining the vowel and vowel sound combinations present within the retrieved word. Each retrieved word may have one or more vowel and vowel sound combinations present. In step 112, the method 100 comprises positioning the associated pictograph 200 relative to each determined vowel and vowel sound combination for display to the student user 900. In an exemplary embodiment, the pictograph 200 may replace the associated vowel and vowel sound combination, referred to as tier one difficulty. In another exemplary embodiment, the pictograph 200 may be positioned above the associated vowel and vowel sound combination, referred to as tier two difficulty. In yet another exemplary embodiment, the method 100 may display the retrieved word and vowel and vowel sound combination without displaying the associated vowel and vowel sound combination, referred to as tier three difficulty. In FIG. 3, there is illustrated exemplary words and vowel and vowel sound combination with associated pictographs in the tier two difficulty.

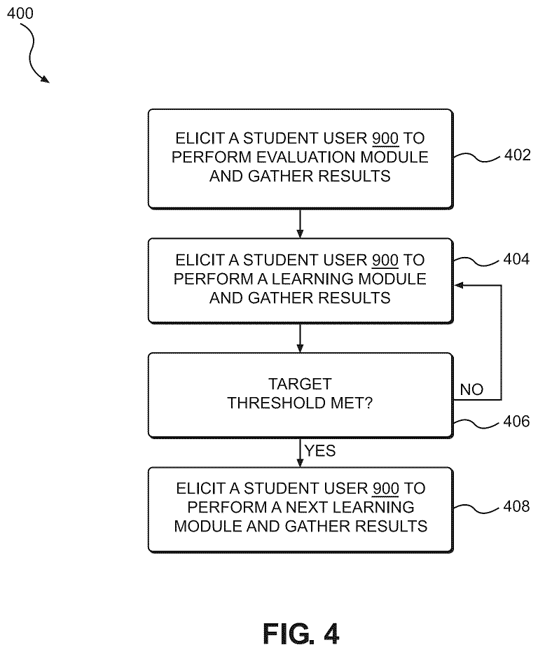

Referring now to FIG. 4, a flow diagram of a method 400 of instructing and evaluating the student user 900 is shown. In step 402, the method 400 comprises presenting an evaluation module to the student user 900 and eliciting the student user 900 to complete the evaluation module. In an exemplary embodiment, the evaluation module may comprise presenting a variety of words or phrases to the student user at different speeds and at different complexity levels. In an exemplary embodiment, the evaluation module may dynamically select words in the module based on the answers or degree of accuracy of answers to previously presented words. In another exemplary embodiment, the evaluation module may comprise altering the speed or pacing of the presented words based on performance of the student user 900. In this exemplary embodiment, the evaluation module may be configured to initially present the words or phrases at a baseline speed/frequency and may adjust the speed/frequency based on the student user's 900 performance in completing each presented word or phrase. In an exemplary embodiment, a teacher user 902 may set the baseline speed/frequency for initial evaluation of the student user 900. The results of the evaluation module are gathered for later analysis.

In step 404, the method 400 elicits the student user 900 to perform a learning module. In an exemplary embodiment, the learning module may be selected based on the student user's 900 performance during the evaluation module. This selection of a learning module may be performed automatically (e.g., via software) or may be performed manually by the teacher user 902. In another exemplary embodiment, the learning module may be selected based on a predetermined selected learning module. In an exemplary embodiment, the student user 900 may be shown a series of words with pictographs 200 inserted to assist the student user 900 in identifying different vowel and vowel sound combinations. In step 406, the method 400 analyzes the student user's 900 performance in the learning module. If the student user 900 fails to exceed a predetermined target threshold, the method 400 elicits the student user to complete the learning module again. In an exemplary embodiment, the repeated learning module may comprise the same words or phrases presented previously. In an alternative embodiment, the repeated learning module may comprise different words or phrases at the same difficulty tier. If the student user 900 has exceeded the predetermined target threshold, the method 400 elicits the student user 900 to perform a next learning module (step 408). In an exemplary embodiment, the next learning module may be at a different difficulty tier teaching the same concepts or may also be a new teaching concept. In an exemplary embodiment, the method 400 is configured to be utilized in conjunction with in-person learning taught by the teacher user 902, wherein the method 400 facilitates the student user 900 practicing and reinforcing the taught concepts. In an alternative embodiment, the method 400 may be utilized as a stand-alone teaching tool, such that the student user 900 is taught and subsequently practices the teaching concepts using the method 400.

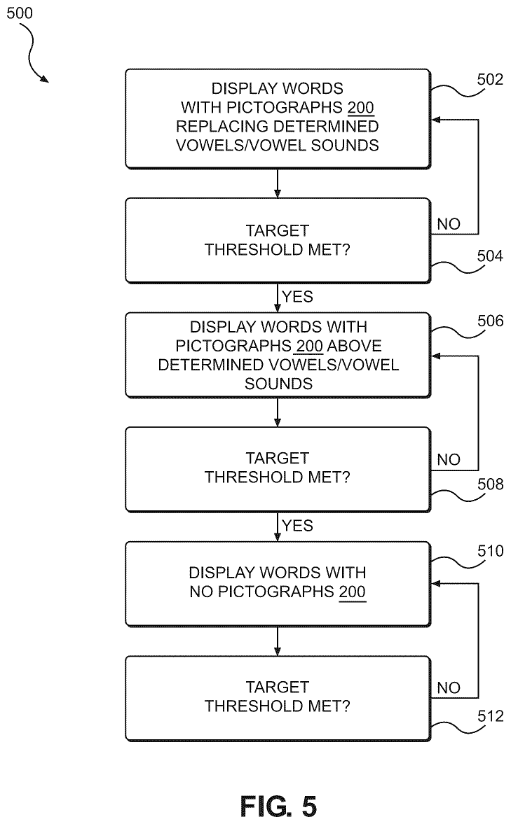

Referring now to FIG. 5, a flow diagram of a method 500 of increasing a difficulty tier within a learning module is shown. In step 502, the student user 900 has been elicited to perform a learning module at a tier one difficulty level. In an exemplary embodiment, the tier one difficulty level displays words to the student user 900 with pictographs 200 replacing the vowel and vowel sound combination. The method 500 tracks and gathers information regarding the student user's 900 progress, then (in step 504) the method 500 determines if the student user 900 has exceeded a predetermined target threshold at the tier one difficulty. If the student user has not met the target threshold, the student user 900 is elicited to perform the learning module at tier one difficulty again either automatically or manually by the teacher user 902, and the method 500 again evaluates the student user's 900 performance. If the student user 900 exceeds the target threshold at the tier one difficulty, the method 500 elicits the student user 900 to perform a learning module at the tier two difficulty either automatically or manually by the teacher user 902. In an exemplary embodiment, in the tier two difficulty, the method 500 displays the pictographs 200 above the associated vowel and vowel sound combination within displayed words. As above, the method 500 tracks and gathers information regarding the student user's 900 progress, then (in step 508) the method 500 determines if the student user 900 has exceeded a predetermined target threshold at the tier two difficulty. If the student user 900 has not met the target threshold, the student user 900 is elicited to perform the learning module at tier two difficulty again either automatically or manually by the teacher user 902, and the method 500 again evaluates the student user's 900 performance. If the student user 900 exceeds the target threshold at the tier two difficulty, the method 500 elicits the student user 900 to perform a learning module at the tier three difficulty either automatically or manually by the teacher user 902. In an exemplary embodiment, in the tier three difficulty, the method 500 displays the words with no associated pictographs 200. As at both above difficulty tiers, the method 500 tracks and gathers information regarding the student user's 900 progress, then (in step 508) the method 500 determines if the student user 900 has exceeded a predetermined target threshold at the tier three difficulty. If the student user 900 has not met the target threshold, the student user 900 is elicited to perform the learning module at tier three difficulty again either automatically or manually by the teacher user 902, and the method 500 again evaluates the student user's 900 performance. If the student user 900 has exceeded the target threshold, the student user 900 may proceed to a next learning module at a tier one difficulty either automatically or manually by the teacher user 902. In an exemplary embodiment, the steps of the method 500 may be conducted automatically by a software program or may be manually executed by a teacher user 902. For example, the teacher user 902 may assign a learning module at a tier one difficulty to the student user 900, and subsequently receive the results of the learning module. Based on the student user's 900 score, the teacher user 902 may advance the student user 900 to the tier two difficulty or may have the student user 900 reinforce the learning at tier one difficulty by repeating the learning module.

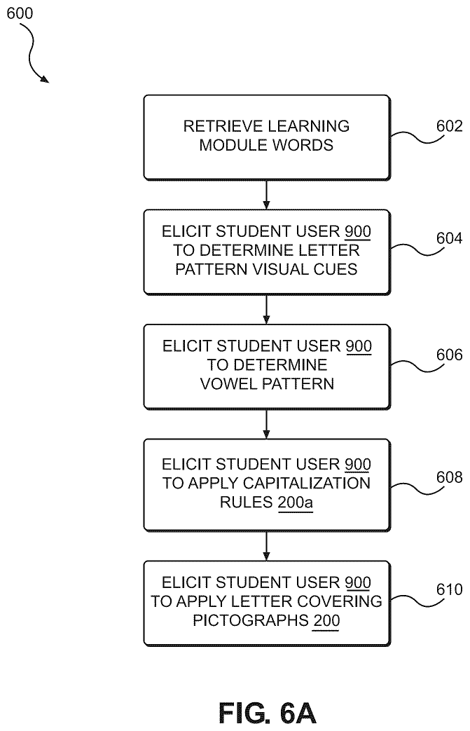

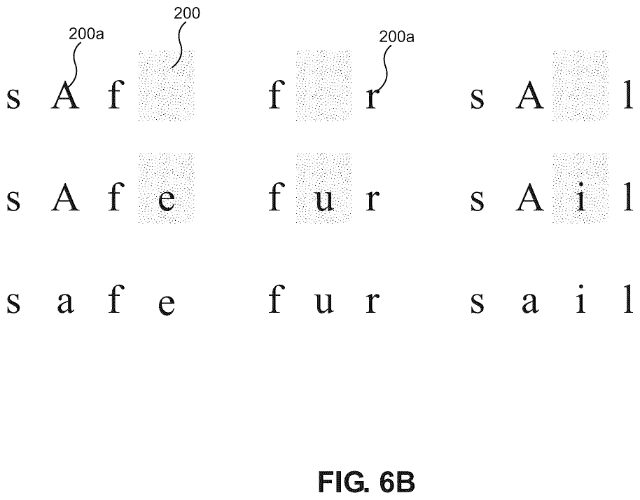

Referring now to FIGS. 6A-6B, a flow diagram of a method 600 of reinforcing vowel and vowel sound combination recognition is shown. In step 602, the method 600 retrieves one or more words from an associated learning module for display to the student user 900. In step 604, the student user 900 is elicited to study the displayed words to determine and recognize the vowel and vowel sound combination present in the word. In step 606, the student user 900 is elicited to determine any vowel patterns that may be present within the displayed word. In step 608, the method 600 elicits the student user 900 to apply vowel capitalization pictograph 200a (see FIG. 6B) to each displayed word. In an exemplary embodiment, the capitalization pictograph 200a is applied whenever an associated vowel has a phonetic long vowel sound (e.g., “e” being shown as “E” to represent the “ee” pronunciation sound). In step 610, the method 600 elicits the user to apply pictographs 200 to cover any silent letters. For example, as shown in FIG. 6B, the silent “e” at the end of the word “safe” has the blanking pictograph 200 covering it. In such an embodiment, the pictograph 200 covers the silent letter to remind the student user 900 that the specific letter is not pronounced when saying the word.

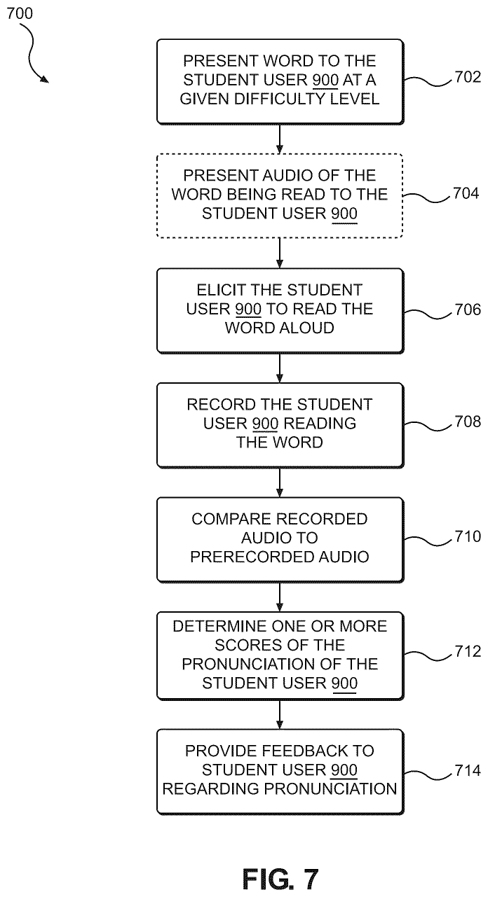

Referring now to FIG. 7, a flow diagram of a method 700 of incorporating audio and speaking components within a learning module is shown. In step 702, the method 700 presents one or more words to the student user 900 at a given difficulty level (i.e., tier one, tier two, or tier three). In step 704, the method 700 presents an audio of the displayed one or more words to the student user 900. In a preferred embodiment, the audio is presented to the student only after the student has spoken the word (see step 708 below), if the student was not successful in pronouncing the word. In an exemplary embodiment, the audio may be played through speakers integrally connected to a computer or mobile device, headphones connected in a wired or wireless manner to the computer, and/or any other suitable audio playing device. In step 706, the method 700 elicits the student user 900 to pronounce the displayed word. In step 708, the method 700 records the student user 900 pronouncing the displayed word. In an exemplary embodiment, the student user 900 may speak the word into a microphone integrally connected to the computer or mobile device, into a microphone connected in a wired or wireless manner to the computer, and/or into any other suitable voice recording device. In an exemplary embodiment, the student user 900 may play the recorded audio pronunciation back to themselves to hear and improve the pronunciation.

In step 710, the method 700 compares the recorded audio of the student user 900 pronouncing the displayed word to the prerecorded audio pronunciation of the displayed word. In an exemplary embodiment, in step 712, the method 700 may determine a pronunciation score, an accuracy score, a fluency score, a comprehension score, and/or any other suitable score. In an exemplary embodiment, the target threshold (as discussed above) may comprise comparing a determined score against a predetermined score. For example, the target threshold may comprise an accuracy score threshold. In another exemplary embodiment, the target threshold may comprise an average or weighted average of two or more scores. For example, the target threshold may comprise an average of an accuracy score threshold and pronunciation score, in equal or unequal weighting. In an exemplary embodiment, the method 700 analyzes the recorded audio to determine if the student user 900 pronounced through the word, as opposed to pronouncing each letter or sound independently and distinctly from each other. In step 714, the method 700 provides feedback to the student user 900 regarding pronunciation of the displayed word. In an exemplary embodiment, the feedback may comprise an indication of pass/fail relative to the target threshold (e.g., a green check for pass, a red “x” for fail). In another exemplary embodiment, the method 700 may display the determined scores for the student user 900.

Those skilled in the art will recognize improvements and modifications to the preferred embodiments of the present disclosure. All such improvements and modifications are considered within the scope of the concepts disclosed herein and the claims that follow.

What is claimed is:

1. A method for learning phonetic pronunciation of words utilizing a plurality of learning modules, the method comprising:
presenting a first learning module of the plurality of learning modules to a student user at a difficulty tier;
eliciting the student user to perform the learning module;
tracking a performance of the student user in performing the learning module;
determining if the performance of the student user exceeded a target threshold;
if the performance of the student user did not exceed the target threshold, eliciting the student user to perform the learning module at the same difficulty tier; and
if the performance of the student user exceeds the target threshold, eliciting the student user to perform the learning module at another difficulty tier and/or another learning module at the same difficulty tier.

2. The method of claim 1, wherein eliciting the student user to perform the learning module further comprises:
presenting one or more words to the student user;
eliciting the student user to pronounce the one or more words aloud; and
recording the student user pronouncing the one or more words aloud.

3. The method of claim 2, wherein the tracking a performance of the student user in performing the learning module further comprises:
comparing the recorded audio of the student user pronouncing the one or more words aloud to a prerecorded audio of the one or more words being pronounced aloud; and
determining one or more scores of the student user pronouncing each of the one or more words aloud.

4. The method of claim 3, wherein the one or more scores comprises a pronunciation score, an accuracy score, a fluency score, and/or a comprehension score.

5. The method of claim 3, wherein the determining if the performance of the student user exceeded a target threshold further comprises comparing the one or more scores with a predetermined target threshold score.

6. The method of claim 5, wherein the one or more scores comprises an accuracy score and the predetermined target threshold score comprises a predetermined accuracy threshold score.

7. The method of claim 1, wherein eliciting the student user to perform the learning module further comprises:
presenting to the student user one or more words;
eliciting the student user to determine letter patterns and/or vowel patterns in each of the one or more words;
eliciting the student user to apply letter capitalization rules; and
eliciting the student user to apply letter covering pictographs.

8. The method of claim 1, wherein the method comprises at least three difficulty tiers.

9. The method of claim 8, wherein:
a first difficulty tier of the at least three difficulty tiers comprises displaying one or more words to the student user with pictographs replacing vowel and vowel sound combinations;
a second difficulty tier of the at least three difficulty tiers comprises displaying the one or more words to the student user with the pictographs placed above the vowel and vowel sound combinations; and
a third difficulty tier of the at least three difficulty tiers comprises displaying the one or more words to the student user without any pictographs.

10. The method of claim 1, wherein the eliciting the student user to perform the learning module at another difficulty tier and/or another learning module at the same difficulty tier is accomplished automatically or by a teacher user.
